(19) United States
(12) Patent Application Publication
(10) Pub. No.: US 2008/0220391 A1
(43) Pub. Date: Sep. 11, 2008

(54) Foot actuator adapted to be used with a dental chair

(75) Inventors: Donald W. Temple, Abbotsford (CA); Thomas J. Lydynuik, Surrey (CA); Anton Simor, Lake Errock (CA); Avner I. Bachar, Abbotsford (CA); Stefan Steiger, Chilliwack (CA)

Correspondence Address: FREDERICK KAUFMAN, SUITE #403, 1937 PENDRELL STREET, VANCOUVER, BC, V6G 1T4, CA

(73) Assignee: GLOBAL DENTAL DIRECT INC.

(21) Appl. No.: 12/072,872

(22) Filed: Feb. 29, 2008

(30) Foreign Application Priority Data
Mar. 7, 2007 (CA) 2,581,246

(51) Int. Cl. A61G 15/10

(52) U.S. Cl. 433/101

(57) ABSTRACT

The actuator incorporates a foot subassembly for selectively controlling either any movement of the chair or a use of a handpiece, comprises a main board subassembly for a) controlling the movements and positions of the chair and for supplying power to a foot subassembly for selectively controlling; and/or b) converting for further transmitting a linear voltage existing in the foot subassembly for selectively controlling, from analog to digital values; a control subassembly for a) activating the handpiece; b) controlling, via a touchpad, the movements and other functional features of the chair; and c) monitoring for displaying all activities of the chair; air valve subassembly for regulating a quantity of air that passes through it and, hence, a pressure supplied to the handpiece via a solenoid valve; and a display unit for viewing the status and activities of the chair.

### I. BACKGROUND OF THE INVENTION

1. Technical Field

The present invention relates in general to actuators for medical treatment apparatuses. In particular, the present invention relates to a foot actuator adapted to be used with a dental chair.

2. Description of the Prior Art

With advances in dental technology, dental offices must provide space for a large number of different apparatuses and instruments. Since a need exists, attempts have been made to develop a compact and reliable foot actuator for dental chairs. For example, United States Patent Application No. 2006/0134578, published Jun. 22, 2006 and entitled “MEDICAL TREATMENT DEVICE”; United States Patent Application No. 2006/0127842, published Jun. 15, 2006 and entitled “INTEGRATED DENTAL EQUIPMENT”; U.S. Pat. No. 6,866,507, granted Mar. 15, 2005 and entitled “FOOT SWITCH”; U.S. Pat. No. 5,422,521, granted Jun. 6, 2005 and entitled “FOOT OPERATED CONTROL SYSTEM FOR A MULTI-FUNCTION DEVICE”; and International Application Published under PCT No. 2005/060858, published Jul. 7, 2005 and entitled “INTEGRATED DENTAL EQUIPMENT” generally constitute related references.

The inventors believe that the subject matter of these references neither anticipate nor render obvious the present invention. The citation of these references does not constitute an admission that they are relevant or material to the claimed subject matter of the presently submitted invention. Rather, these references relate only to the general field of the present invention and are cited as constituting the closest art of which the inventors are aware.

### II. SUMMARY OF THE INVENTION

A first objective of the present invention is to provide a method and a foot actuator based on the method, which allow to direct all the operations and movements related to a dental chair.

A second objective of the present invention is to develop a foot actuator for a dental chair, which

preserves its operating capacity during an anticipated service life, with the minimum cost of maintenance and repairs.

A third objective of the present invention is to provide a foot actuator for a dental chair, which is more convenient and safer servicing.

A fourth objective of the present invention is to provide a foot actuator for a dental chair, wich satisfies the demands of technical aesthetics.

Broadly stating, a foot actuator, adapted for use with a dental chair, according to the present invention comprises in combination:
a foot assembly subassembly for selectively controlling either any movement of the dental chair or a use of a dental handpiece, a use of the former preventing a use of the latter or vice versa);
a main board subassembly for a) controlling the movements and positions of the dental chair and for supplying power to the foot subassembly for selectively controlling; and/or b) converting for further transmitting a linear voltage existing in the foot subassembly for selectively controlling and the linear voltage from analog to digital values;
a control subassembly for a) activating the dental handpiece, so that the latter could perform its preestablished operations; b) controlling, via a touchpad, the movements and other functional features of the dental chair; and c) monitoring for displaying all activities of the dental chair;
air valve subassembly for regulating a quantity of air that passes through it and, hence, a pressure supplied to the dental handpiece via a solenoid valve; and
use is made of a display unit for viewing the status and activities of the dental chair. I

In one aspect of this invention, the foot subassembly means for selectively controlling includes a body comprising
a base plate, on which a cavity provided cover is superposed;
a circuit bord permanently attached to the plate;
a mechanical biasing unit, centrally located on the circuit board, including
   a central sliding pin provided at its lower extremity with a magnet;
   a disc-plate spaced from and attached to, via several legs passing through the circuit board, the base plate; the disc-plate being provided with a central aperture, so dimensioned as to allow an easy passage of the central sliding pin; a push button being fastened to the central sliding pin at an upper extremity of the latter, and a coil spring being interposed between the push button and the disc-plate.

The circuit board incorporates
a programmable linear Hall, conveniently located as to interact with the magnet;
four switching sensors equally spaced on a periphery of the circuit board and equally spaced from the geometrical center of the latter; the four switching sensors being able to be magnetically activated when they are not of programmable linear Hall sensor type; and
a connector for 1) supplying power to the circuit board; 2) receiving programming signals for the latter; and 3) transmitting electrical signals from the sensors;
   the cavity provided cover has four magnets so disposed as to be vertically aligned with the four switching sensors, a central interior zone of the cavity provided cover being in permanent contact with the push button, and an upper part of the cavity provided cover being upwardly inclined towards its front, the cavity provided cover ending at is bottom with a circular narrow flange extending radially towards the center of the former; a discontinuous cylindrical retainer ending at its upper part with an annular narrow flange for superpositioning, after insertion into the interior of the cavity provided cover, on the circular narrow flange; the discontinuous cylindrical retainer being removably secured to the base plate by conventional connecting features; and
when a user of the foot subassembly for selectively controlling employs his/her tip of a foot to press on a front part of the cavity provided cover, the heel of the foot is supported for pivoting outside the latter;

The main board subassembly means for a) controlling the movements and positions of the dental chair and for supplying power to said foot subassembly means for selectively controlling; and/or b) converting for further transmitting a linear voltage existing in the foot subassembly means for selectively controlling and changing the linear voltage from analog to digital values, comprising

a PCB on which are mounted the following main components:
a microcontroller for controlling a) the motions of the dental chair 15; b) a communication between said main board subassembly and other operational features of the dental chair; and c) stored firmware and quantitatively operational established values;
a power supply circuit for supplying power to the main board subassembly for its own use and for other external uses;
a solenoid and pump control circuit for delivering power, respectively to a solenoid block and a pump, both parts of the dental chair and for simultaneously indicating if a solenoid of the solenoid block and the pump are activated;
a programming port for loading the stored firmware into the microcontroller;
a communication port for connecting the main board subassembly with the control subassembly;
a foot control connector for supplying power to the foot subassembly for selectively controlling and receiving electrical signals from the sensors; and
a pair of connectors for programming new chair positions and recalling preprogrammed, stored positions of the dental chair;
   the control subassembly for a) activating the dental handpiece, so that the latter could perform its preestablished operations; b) controlling, via a touchpad, the movements and other functional features of the dental chair; and c) monitoring for displaying all activities of the dental chair including a PCB on which are mounted the following main components:
a microcontroller for controlling a) all the operations related to the handpiece; b) a communication between the control subassembly and other operational features shown on the touchpad; c) said stored firmware and quantitatively operational established values; and information to be displayed on the display unit;
a power supply circuit for supplying power to the control subassembly for its own use and for other external uses;
a programming port for loading the stored firmware into the microcontroller;
a communication port for connecting said control subassembly with the main board subassembly means;
a dental handpiece sensing circuit for detecting that a the dental handpiece is in use;
a fiber optic circuit for illuminating a bulb in a said handpiece in use;
a solenoid valve circuit for allowing a passage of air flow to a said handpiece in use;
a pressure sensor circuit for measuring air pressure in a said handpiece in use;
a proportional valve control circuit for converting and amplifying the signals from said programmable linear Hall sensor and transmitting a resulting linear voltage to the air valve subassembly for regulating a quantity of air that passes through it, and, thus controlling a speed of the dental handpiece;
a LCD control circuit for supplying power to and for displaying information on a graphic LCD module; and
a video on screen display module that is used to show the dental chair's status on a TFT video screen.

Another aspect of this invention is a method of foot actuating for use with a dental chair, which method is defined by the following basic operation:
selectively controlling with one foot subassembly either any movement of the dental chair or a use of dental handpiece, so that a use of the former prevents a use of the latter or vice versas, the foregoing basic operation requiring, for carrying it out, the following operational steps:
activating a foot subassembly for sending a signal to a main board subassembly, wherein a microcontroller basically determines all motion related operations of the dental chair and sends a signal to control subassembly to disable a proportional valve control circuit in an air valve subassembly by not supplying a voltage to a solenoid valve in the air valve subassembly, thus the dental handpiece cannot be used; and
   when the dental handpiece is removed from a non use position with an intention to be used, a control subassembly sends a signal to the main board subassembly to disable al motion related operations of the dental chair, concomitantly activating the air valve subassembly to allow an air flow to the dental handpiece, the air flow being controlled by
supplying a linear voltage by the control subassembly to an air valve subassembly.

### III. BRIEF DESCRIPTION OF THE DRAWINGS

Although the characteristic features of the invention will be particularly pointed out in the claims, the invention itself and the manner in which it may be made and used may be better understood by referring to the following description and accompanying drawings. accompanying drawings. Like reference numerals refer to like parts throughout the several views of the drawings in which:

FIG. 1 is a foot actuator assembly according to the present invention;

FIG. 2 is foot subassembly for selectively controlling;

FIG. 3 is a main board subassembly;

FIG. 4 is a control subassembly;

FIG. 5 shows the components used to carry out the method;

FIG. 6 shows the components used to carry out a variant of the method.

### IV. DESCRIPTION OF THE PREFERRED EMBODIMENT

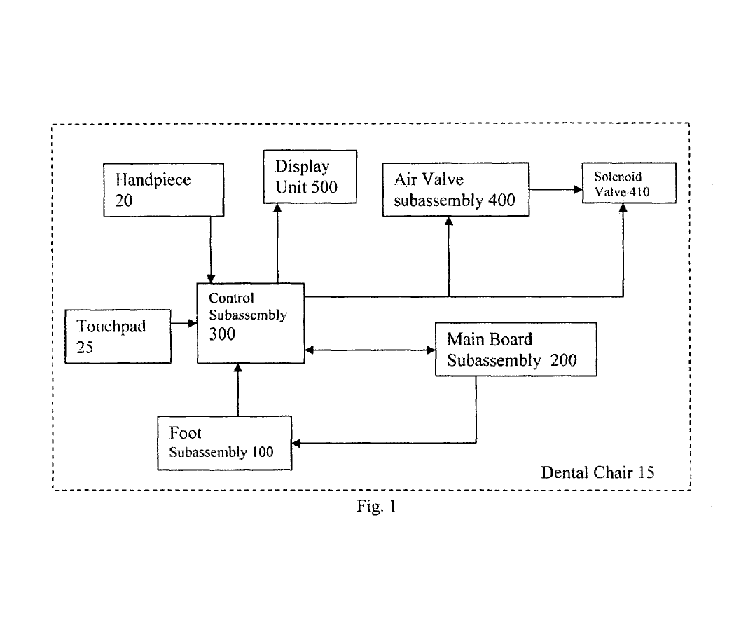

A foot actuator assembly 10 (see FIG. 1), adapted for use with a dental chair 15, comprises in combination:
a foot subassembly for selectively controlling 100 either any movement of dental chair 15 or a use of dental handpiece 20 (a use of the former prevents a use of the latter or vice versa);
a main board subassembly 200 for a) controlling the movements and positions of dental chair 15 and for supplying power to foot subassembly for selectively controlling 100; and/or b) converting for further transmitting a linear voltage existing in foot subassembly for selectively controlling 100 and changing the linear voltage from analog to digital values;
a control subassembly 300 for a) activating handpiece 20, so that the latter could perform its preestablished operations; b) controlling, via a touchpad 25, the movements and other functional features of dental chair 15; and c) monitoring for displaying all activities of dental chair 15;
an air valve subassembly 400 for regulating a quantity of air that passes through it and, hence, a pressure supplied to handpiece 20 via a solenoid valve 410; and
in one variant use is made of a display unit 500 for viewing the status and activities of dental chair 20.

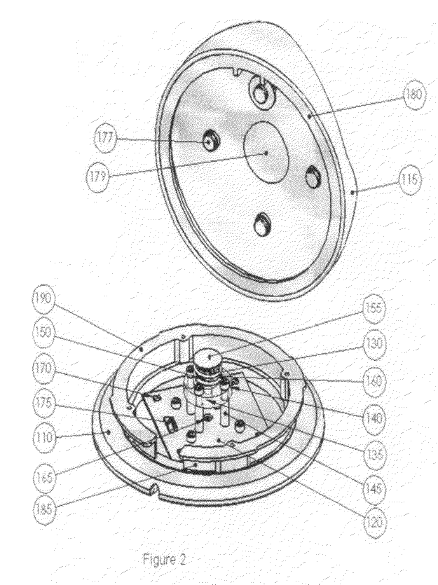

Foot subassembly for selectively controlling 100 (see FIG. 2) includes a body 105 comprising a base plate 110, on which a cavity provided cover 115 is superposed. A circuit bord 120 is permanently attached to base plate 110.

A mechanical biasing unit 125 is centrally located on circuit board 120.

Describing in detail foot assembly for selectively controlling 100 (see FIG. 2), mechanical biasing unit 125 includes a central sliding pin 130 provided at its lower extremity with a magnet 135. Mechanical biasing unit 125 further incorporates a disc-plate 140 spaced from and attached to, via several legs 145 passing through circuit board 120, base plate 110. Disc-plate 140 is provided with a central aperture 150, so dimensioned as to allow an easy passage of central sliding pin 130. A push button 155 is fastened to central sliding pin 130, at an upper extremity of the latter, and a coil spring 160 is interposed between push button 155 and disc-plate 140.

Alternatively to mechanical biasing unit 125, use can be made of an air valve mechanism which would eliminate the programmable linear Hall sensor and air valve subassembly 400.

Circuit board 120 incorporates
a programmable linear Hall sensor165, conveniently located as to interact with magnet 135;
four switching sensors 170 equally spaced on the periphery of circuit board 120 and equally spaced from the geometrical center of the latter; four switching sensors 170 can be magnetically activated and they can be also of programmable linear Hall sensor type; and
connector 175 for 1) supplying power to circuit board 120; 2) for receiving programming signals for the latter; and 3) transmitting electrical signals from the foregoing sensors (165 and 170).

Cavity provided cover 115 has four magnets 177 so disposed as to be vertically aligned with four switching sensors 170. A central interior zone 179 of cavity provided cover 115 is in permanent contact with push button 155. The upper part of cavity provided cover 115 is upwardly inclined towards its front. Cavity provided cover 115 ends at is bottom with a circular narrow flange 180 extending radially towards the center of the former.

A discontinuous cylindrical retainer 185 ends at its upper part with an annular narrow flange 190 for superpositioning, after insertion into the interior of cavity provided cover 115, on circular narrow flange 180. Discontinuous cylindrical retainer 185 is removably secured to base plate 110 by conventional connecting features (not shown).

When a user of foot subassembly for selectively controlling 100 employs his/her tip of a foot to press on the front part of cavity provided cover 115, the heel of the foot is supported for pivoting outside the latter. Therefore, the upper part of cavity provided cover 115 is upwardly inclined towards its front.

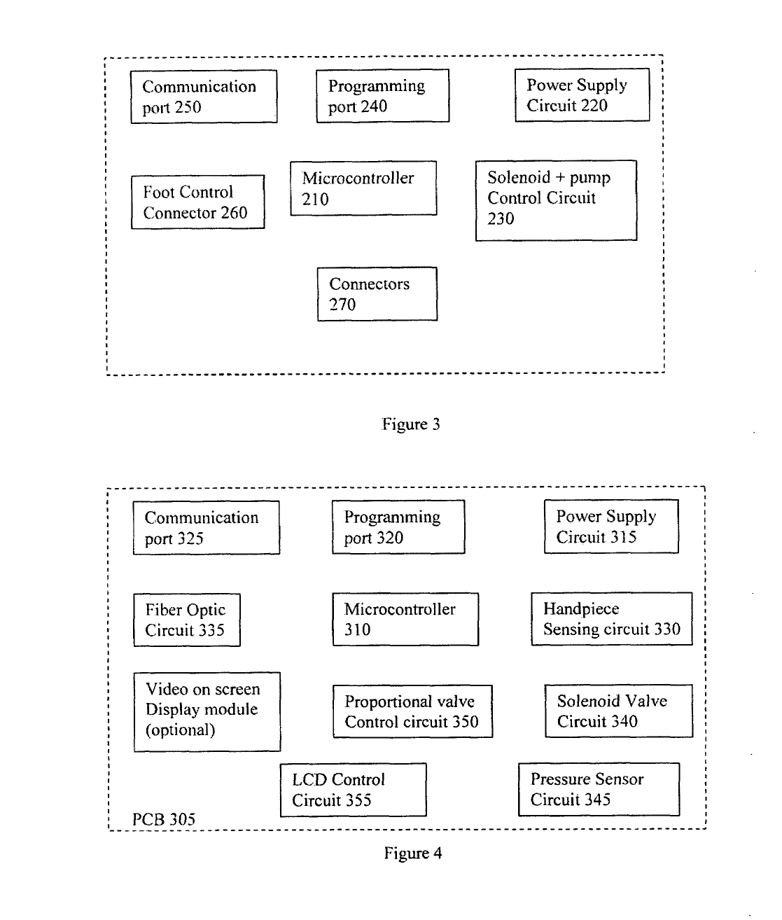

Main board subassembly 200 (see FIG. 3) includes a PCB on which are mounted the following main components:
a microcontroller 210 for controlling a) the motions of dental chair 15; b) a communication between main board subassembly 200 and other operational features of dental chair 15; and c) stored firmware and quantitatively operational established values;
a power supply circuit 220 for supplying power to main board subassembly 200 for its own use and for other external uses;
solenoid and pump control circuit 230 for delivering power, respectively to a solenoid block and a pump (not shown), both parts of dental chair 15 and for simultaneously indicating if a solenoid of the solenoid block and the pump are activated;
a programming port 240 for loading stored firmware into microcontroller 210;
a communication port 250 for connecting main board subassembly 210 with control subassembly 300;
a foot control connector 260 for supplying power to foot subassembly for selectively controlling 100 and receiving electrical signals from the foregoing sensors (165 and 170); and
two connectors 270 for programming new chair positions and recalling preprogrammed, stored dental chair 15 positions.

Control subassembly 300 (see FIG. 4) includes a PCB 305 on which are mounted the following main components:
a microcontroller 310 for controlling a) all the operations related to handpiece 20; b) a communication between control subassembly 300 and other operational features shown on touchpad 25; c) stored firmware and quantitatively operational established values; and information to be displayed on display unit 500;
a power supply circuit 315 for supplying power to control subassembly 300 for its own use and for other external uses;
a programming port 320 for loading stored firmware into microcontroller 310;
a communication port 325 for connecting control subassembly 300 with main board subassembly 210;
a handpiece sensing circuit 330 for detecting that handpiece 20 is in use;
fiber optic circuit 335 for illuminating a bulb (non shown) in a handpiece 20 in use;
solenoid valve circuit 340 for allowing a passage of air flow to a handpiece 20 in use;
a pressure sensor circuit 345 for measuring air pressure in a handpiece 20 in use;
a proportional valve control circuit 350 for converting and amplifying the signals from programmable linear Hall sensor165 and transmitting a resulting linear voltage to air valve subassembly 400, thus controlling a speed of handpiece 20;
a LCD control circuit 355 for supplying power to and for displaying information on a graphic LCD module (not shown); and, optionally,
a video on screen display module that is used to show dental chair's 15 status on a TFT video screen.

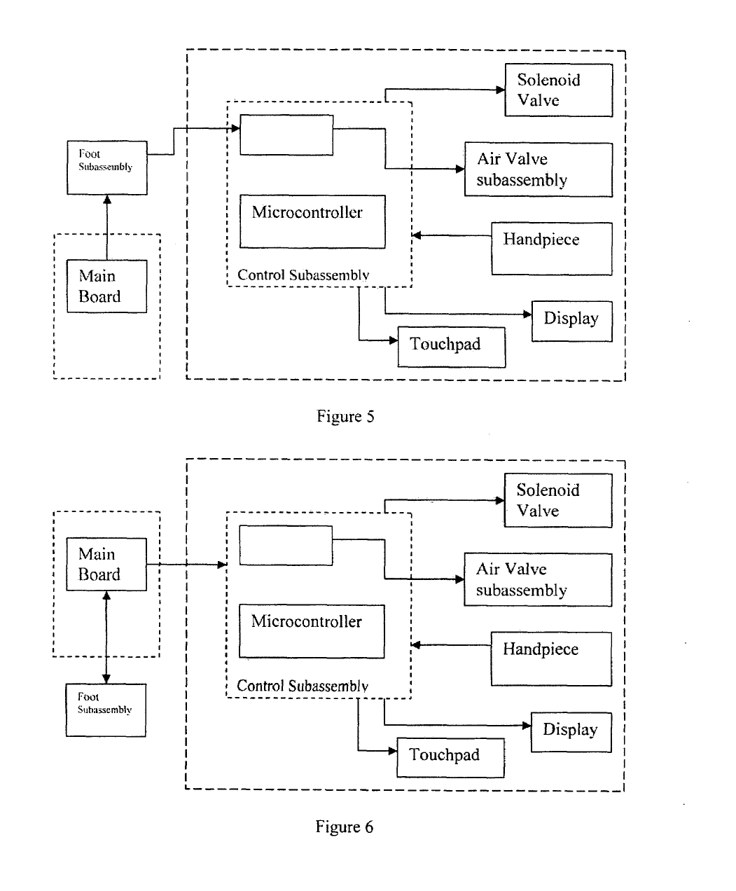

Control subassembly 300 can receive the linear voltage directly from foot subassembly 100 or from main board subassembly 200 (see FIGS. 5 and 6).

A method of foot actuating for use with a dental chair (see FIGS. 5 and 6), defined by the following basic operation:
selectively controlling with one foot subassembly either any movement of said dental chair or a use of dental handpiece, so that a use of the former prevents a use of the latter or vice versas, the foregoing operational step requiring, for carrying it out, the following operational steps
   activating a foot subassembly for sending a signal to a main board subassembly, wherein a microcontroller basically determines all motion related operations of the dental chair and sends a signal to control subassembly to disable a proportional valve control circuit in an air valve subassembly by not supplying a voltage to a solenoid valve in the air valve subassembly, thus the dental handpiece cannot be used; and
   when the dental handpiece is removed from a non use position with an intention to be used, a control subassembly sends a signal to the main board subassembly to disable al motion related operations of the dental chair, concomitantly activating the air valve subassembly to allow an air flow to the dental handpiece, the air flow being controlled by
supplying a linear voltage by the control subassembly to the air valve subassembly.

As required, a detailed embodiment of the present invention is disclosed herein; however, it is to be understood that the disclosed embodiment is merely exemplary of the invention which may be embodied in various forms. Therefore, specific structural and functional details disclosed herein are not to be interpreted as limiting, but merely as a basis for the claims and as representative basis for teaching one skilled in the art to variously employ the present invention in virtually any appropriately detailed structure.

The embodiments of the invention in which an exclusive property or privilge is claimed are defined as follows:

1. A foot actuator, adapted for use with a dental chair, comprising in combination:
foot assembly means for selectively controlling either any movement of said dental chair or a use of a dental handpiece, a use of the former preventing a use of the latter or vice versa);
main board subassembly means for a) controlling the movements and positions of said dental chair and for supplying power to said foot subassembly means for selectively controlling; and/or b) converting for further transmitting a linear voltage existing in said foot subassembly means for selectively controlling, and for changing linear voltage from analog to digital values;
control subassembly means for a) activating said dental handpiece, so that the latter could perform its preestablished operations; b) controlling, via a touchpad, the movements and other functional features of said dental chair; and c) monitoring for displaying all activities of said dental chair;
air valve subassembly means for regulating a quantity of air that passes through it and, hence, a pressure supplied to said dental handpiece via a solenoid valve; and
a display unit for viewing the status and activities of said dental chair.

2. as defined in claim 1, wherein
said foot subassembly means for selectively controlling includes a body comprising
a base plate, on which a cavity provided cover is superposed;
a circuit bord permanently attached to said base plate;
a mechanical biasing unit, centrally located on said circuit board, including
a central sliding pin provided at its lower extremity with a magnet;
a disc-plate spaced from and attached to, via several legs passing through said circuit board, said base plate; said disc-plate being provided with a central aperture, so dimensioned as to allow an easy passage of said central sliding pin; a push button being fastened to said central sliding pin at an upper extremity of the latter, and a coil spring being interposed between said push button and said disc-plate;
said circuit board incorporating
a programmable linear Hall, conveniently located as to interact with said magnet;
four switching sensors equally spaced on a periphery of said circuit board and equally spaced from the geometrical center of the latter; said four switching sensors being able to be magnetically activated when they are not of programmable linear Hall sensor type; and
a connector for 1) supplying power to said circuit board; 2) receiving programming signals for the latter; and 3) transmitting electrical signals from said sensors;
said cavity provided cover having four magnets so disposed as to be vertically aligned with said four switching sensors, a central interior zone of said cavity provided cover being in permanent contact with said push button, and an upper part of said cavity provided cover being upwardly inclined towards its front, said cavity provided cover ending at is bottom with a circular narrow flange extending radially towards the center of the former;
a discontinuous cylindrical retainer ending at its upper part with an annular narrow flange for superpositioning, after insertion into the interior of said cavity provided cover, on said circular narrow flange; said discontinuous cylindrical retainer being removably secured to said base plate by conventional connecting features; and
when a user of said foot subassembly means for selectively controlling employs his/her tip of a foot to press on a front part of said cavity provided cover, the heel of the foot is supported for pivoting outside the latter;
said main board subassembly means for a) controlling the movements and positions of said dental chair and for supplying power to said foot subassembly means for selectively controlling;
and/or b) converting for further transmitting a linear voltage existing in said foot subassembly means for selectively controlling and changing said linear voltage from analog to digital values, comprising
a PCB on which are mounted the following main components:
a microcontroller for controlling a) the motions of said dental chair 15; b) a communication between said main board subassembly and other operational features of said dental chair; and c) stored firmware and quantitatively operational established values;
a power supply circuit for supplying power to said main board subassembly means for its own use and for other external uses;
a solenoid and pump control circuit for delivering power, respectively to a solenoid block and a pump, both parts of said dental chair and for simultaneously indicating if a solenoid of said solenoid block and said pump are activated;
a programming port for loading said stored firmware into said microcontroller;
a communication port for connecting sid main board subassembly means with said control subassembly means;
a foot control connector for supplying power to said foot subassembly for selectively controlling and receiving electrical signals from said sensors; and
a pair of connectors for programming new chair positions and recalling preprogrammed, stored positions of said dental chair;
said control subassembly means for a) activating said dental handpiece, so that the latter could perform its preestablished operations; b) controlling, via a touchpad, the movements and other functional features of said dental chair; and c) monitoring for displaying all activities of said dental chair including a PCB on which are mounted the following main components:
a microcontroller for controlling a) all the operations related to said handpiece; b) a communication between said control subassembly and other operational features shown on said touchpad; c) said stored firmware and quantitatively operational established values; and information to be displayed on said display unit;
a power supply circuit for supplying power to said control subassembly means for its own use and for other external uses;
a programming port for loading said stored firmware into said microcontroller;
a communication port for connecting said control subassembly means with said main board subassembly means;
a dental handpiece sensing circuit for detecting that a said dental handpiece is in use;
a fiber optic circuit for illuminating a bulb in a said handpiece in use;
a solenoid valve circuit for allowing a passage of air flow to a said handpiece in use;
a pressure sensor circuit for measuring air pressure in a said handpiece in use;
a proportional valve control circuit for converting and amplifying the signals from said programmable linear Hall sensor and transmitting a resulting linear voltage to said air valve subassembly means for regulating a quantity of air that passes through it, and, thus controlling a speed of said dental handpiece;
a LCD control circuit for supplying power to and for displaying information on a graphic LCD module; and
a video on screen display module that is used to show said dental chair's status on a TFT video screen.

3. A method of foot actuating for use with a dental chair, defined by the following basic operation:
selectively controlling with one foot subassembly either any movement of said dental chair or a use of dental handpiece, so that a use of the former prevents a use of the latter or vice versas, the foregoing basic operation requiring, for carrying it out, the following operational steps:
activating a foot subassembly for sending a signal to a main board subassembly, wherein a microcontroller basically determines all motion related operations of the dental chair and sends a signal to control subassembly to disable a proportional valve control circuit in an air valve subassembly by not supplying a voltage to a solenoid valve in the air valve subassembly, thus the dental handpiece cannot be used; and
when said dental handpiece is removed from a non use position with an intention to be used, a control subassembly sends a signal to said main board subassembly to disable al motion related operations of said dental chair, concomitantly activating said air valve subassembly to allow an air flow to said dental handpiece, said air flow being controlled by
supplying a linear voltage by said control subassembly to an air valve subassembly.
